(19) United States
(12) Patent Application Publication
(10) Pub. No.: US 2026/0370992 A1
(43) Pub. Date: Nov. 19, 2026

(54) WOODEN-BOX CD PLAYBACK DEVICE WITH IMPROVED SOUND QUALITY

(71) Applicant: Shenzhen Zhonglin Information Technology Co., Ltd., Shenzhen (CN)

(72) Inventor: Weibing HONG, Shenzhen (CN)

(73) Assignee: Shenzhen Zhonglin Information Technology Co., Ltd., Shenzhen (CN)

(21) Appl. No.: 19/681,479

(22) Filed: May 19, 2026

(30) Foreign Application Priority Data
May 19, 2025 (CN) 202520996629.X

(51) Int. Cl. H04R 1/02; G06F 1/16; G11B 25/04; G11B 33/02

(52) U.S. Cl. CPC H04R 1/025; G06F 1/1635; G11B 25/043; G11B 33/025; H04R 2430/01

(57) ABSTRACT

Disclosed in the present disclosure is a wooden-box CD playback device with improved sound quality. A back side of the cover body is hinged to a wooden enclosure, such that the cover body is opened or closed relative to the wooden enclosure; an acoustic chamber assembly includes a speaker, a diaphragm, and the wooden enclosure; a button-volume knob circuit board is fixedly mounted inside the device; a main control circuit board is fixed inside the wooden enclosure by first screws; the main control circuit board, the playback mechanism, and the button-volume knob circuit board are connected via wires to implement signal transmission and control; a tonearm assembly is provided with a tonearm knob and a tonearm encoder; the tonearm encoder is connected to the tonearm knob. The present disclosure solves the problems of muddy sound quality, and poor soundstage performance of conventional CD players.

### CROSS-REFERENCE TO RELATED APPLICATIONS

This application claims priority to Chinese Patent Application No. 202520996629X, filed on May 19, 2025, the content of which is incorporated herein by reference in its entirety.

### TECHNICAL FIELD

The present disclosure relates to a wooden-box CD playback device with improved sound quality, belonging to the technical field of CD players.

### BACKGROUND

As a classic audio playback apparatus, a CD playback device has advantages in sound quality performance that cannot be replaced by digital music. The CD playback device directly acquires analog signals stored on a CD through an optical reading manner, thereby providing a more natural and realistic music experience. With the improvement of people's living standards, the requirements for the sound quality of CD playback devices are also becoming increasingly higher.

Conventional CD playback devices have some deficiencies in structural design, which affect the further improvement of sound quality. For example, enclosures of CD playback devices are usually made of plastic materials. The density and fiber structure of these materials are not conducive to the propagation and reflection of sound waves, and resonance and noise are likely to occur, thereby affecting the purity of sound quality. A CD playback mechanism generates mechanical vibration during operation, and the vibration is transmitted to an audio amplification module through the structure of the device, thereby interfering with audio signals and resulting in sound distortion. In addition, an acoustic chamber structure of a conventional CD playback device is unreasonably designed, and cannot accurately regulate and control a reflection path of sound, so that standing waves are likely to be formed, thereby affecting the layering and stereoscopic impression of sound. Several improvement solutions have been proposed in the prior art. For example, a metal enclosure is adopted to improve the stability and anti-interference capability of the device, but the metal enclosure is likely to generate resonance, thereby negatively affecting sound quality. A damping pad is disposed between the playback mechanism and the audio amplification module to reduce vibration interference, but the effect of the damping pad is limited, and the influence of vibration on sound quality cannot be eliminated.

### SUMMARY

Therefore, the present disclosure provides a wooden-box CD playback device with improved sound quality, which solves the problems of muddy sound quality, loss of detail, and poor soundstage performance caused by large resonance, high sound transmission loss, and poor acoustic environment of conventional CD players.

To achieve the above object, the present disclosure provides the following technical solution: a wooden-box CD playback device with improved sound quality, including a cover body, a wooden enclosure, an acoustic chamber assembly, a button-volume knob circuit board, a main control circuit board, a playback mechanism, a tonearm assembly, and a battery.

A back side of the cover body is hinged to the wooden enclosure, such that the cover body is opened or closed relative to the wooden enclosure.

The acoustic chamber assembly includes a speaker, a diaphragm, and the wooden enclosure, the speaker and the diaphragm being both fixedly mounted on a surface of the wooden enclosure, and the playback mechanism being placed on a plastic mechanism tray.

The button-volume knob circuit board is fixedly mounted inside the device, and the button-volume knob circuit board is configured to control the volume of the device.

The main control circuit board is fixed inside the wooden enclosure by first screws, and the main control circuit board, the playback mechanism, and the button-volume knob circuit board are connected via wires to implement signal transmission and control.

The tonearm assembly is provided with a tonearm knob and a tonearm encoder, and the tonearm encoder is connected to the tonearm knob.

The battery is mounted in a battery mounting position reserved inside the device, and the battery supplies power to the device.

As a preferred solution of the wooden-box CD playback device with improved sound quality, the back side of the cover body is connected to one end of a hinge via a hinge pin, and the other end of the hinge is fixed to the wooden enclosure.

As a preferred solution of the wooden-box CD playback device with improved sound quality, the device further includes a plastic panel mounted at an upper opening of the wooden enclosure, and the plastic panel and the wooden enclosure are connected via silicone rubber screw plugs.

As a preferred solution of the wooden-box CD playback device with improved sound quality, the button-volume knob circuit board is provided with tactile keys, and a plastic button is disposed above each tactile key; and the button-volume knob circuit board is further connected to a volume encoder and an infrared receiving diode, and a plastic volume knob is disposed above the volume encoder.

As a preferred solution of the wooden-box CD playback device with high sound quality, damping silicone rubber is disposed around the playback mechanism, and a plastic mechanism tray is disposed below the damping silicone rubber for supporting the playback mechanism.

As a preferred solution of the wooden-box CD playback device with improved sound quality, the wooden enclosure is made of solid wood or an engineered wood board, the solid wood is selected from one of oak wood, walnut wood or cherry wood, and the engineered wood board is selected from one of medium-density fiberboard, particle board, plywood, or oriented strand board; a wall thickness of the wooden enclosure (23) is 6 cm, 9 cm or 12 cm.

As a preferred solution of the wooden-box CD playback device with improved sound quality, the device further includes a plastic interface, which is fixed to a rear portion of the wooden enclosure by second screws, and the plastic interface includes at least one of an audio output port, a USB port, or a power port.

As a preferred solution of the wooden-box CD playback device with improved sound quality, outer sides of the speaker and the diaphragm are sequentially covered with a dustproof fabric and a speaker grille.

The present disclosure has the following advantages:
1. By adopting a design in which the cover body is hinged to the wooden enclosure, the cover body can be easily opened or closed relative to the wooden enclosure, thereby facilitating placement and replacement of CDs by a user, and the operation is simple and convenient. By being fixed through a defined connection manner and operating cooperatively, the stability of an overall structure of the device is ensured, failures caused by loosening or improper connection of components are reduced, and the service life of the device is prolonged.
2. The speaker and the diaphragm in the acoustic chamber assembly are fixed on the surface of the wooden enclosure, which provides a stable foundation for sound transmission. This structure, combined with a specific acoustic chamber design, facilitates effective transmission and reflection of sound, reduces loss and distortion of sound during transmission, improves the clarity and layering of audio, and brings users a better listening experience.
3. The button-volume knob circuit board is fixed inside the device and has the function of controlling the device volume, and the components, such as tactile keys, plastic buttons, a volume encoder, and an infrared receiving diode arranged thereon, cooperate with each other. The tactile keys and plastic buttons facilitate user operation, the volume encoder can realize precise volume adjustment, and the infrared receiving diode supports remote operation via a remote control, thereby greatly improving the convenience and accuracy of user’s control over the device.
4. The main control circuit board is fixed inside the wooden enclosure by first screws and connected with the playback mechanism, button-volume knob circuit board, and other components via wires. This connection mode ensures stable and efficient signal transmission among all components, enabling the device to accurately respond to various operation instructions and run stably, realizing functions such as playback, pause, track switching, and volume adjustment, and improving the overall performance and user experience of the device.
5. The tonearm encoder in the tonearm assembly is connected to the tonearm knob, the tonearm knob facilitates users to manually operate the tonearm, and the tonearm encoder can accurately detect the tonearm position and feed back signals. The two work in coordination to realize precise positioning of the tonearm, ensure that a pickup head accurately reads information on CDs, reduce sound skipping and reading errors, improve the accuracy and smoothness of music playback, and further optimize sound quality.

### BRIEF DESCRIPTION OF DRAWINGS

To explain the embodiments of the present disclosure or the technical solutions in the prior art more clearly, the following is a brief introduction to the accompanying drawings needed for the description of the embodiments or the prior art. Apparently, the drawings described below are merely exemplary, and those skilled in the art can derive other embodiment drawings from the provided drawings without creative efforts.

The structures, proportions, sizes, etc., depicted in this specification are only intended to match the content disclosed in the specification. For those who are familiar with this technology to understand and read, and are not intended to limit the implementable limiting conditions of the present disclosure. Therefore, they have no technical substantive meaning, and any modification of the structure, change of the proportional relationship, or adjustment of the size that does not affect the efficacy or the intended purpose of the present disclosure shall fall within the scope of the technical content of the present disclosure.

FIG. 1 is a perspective view of a wooden-box CD playback device with improved sound quality according to an embodiment of the present disclosure;

FIG. 2 is another schematic perspective view of the wooden-box CD playback device with improved sound quality according to an embodiment of the present disclosure;

FIG. 3 is a top view of the wooden-box CD playback device with improved sound quality according to an embodiment of the present disclosure;

FIG. 4 is a schematic internal view of the wooden-box CD playback device with improved sound quality according to an embodiment of the present disclosure; and

FIG. 5 is a schematic exploded view of the wooden-box CD playback device with improved sound quality according to an embodiment of the present disclosure.

In the figures: 1. cover body; 2. hinge; 3. plastic panel; 4. playback mechanism; 5. plastic button; 6. damping silicone rubber; 7. plastic interface; 8. hinge pin; 9. first screw; 10. second screw; 11. tonearm knob; 12. main control circuit board; 13. tonearm encoder; 14. plastic volume knob; 15. silicone rubber screw plug; 16. tactile key; 17. button-volume knob circuit board; 18. volume encoder; 19. diaphragm; 20. infrared receiving diode; 21. battery; 22. speaker; 23. wooden enclosure; 24. dustproof fabric; 25. speaker grille.

### DETAILED DESCRIPTION OF THE EMBODIMENTS

The implementation of the present disclosure is described below by means of specific embodiments. Other advantages and effects of the present disclosure can be readily understood by persons skilled in the art from the disclosure of the present specification. Obviously, the described embodiments are merely some embodiments of the present disclosure, rather than all embodiments thereof. Based on the embodiments of the present disclosure, all other embodiments obtained by a person of ordinary skill in the art without creative efforts shall fall within the scope of protection of the present disclosure.

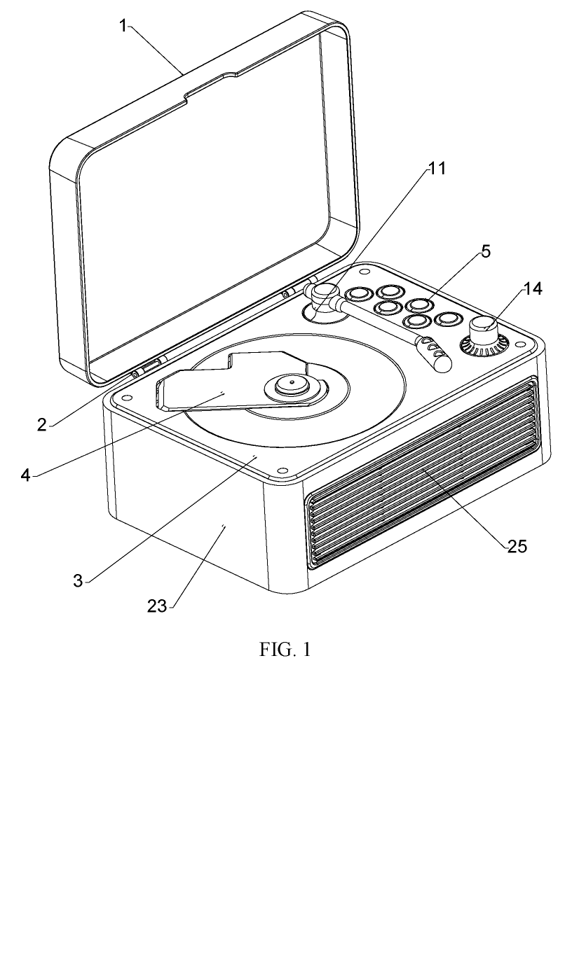

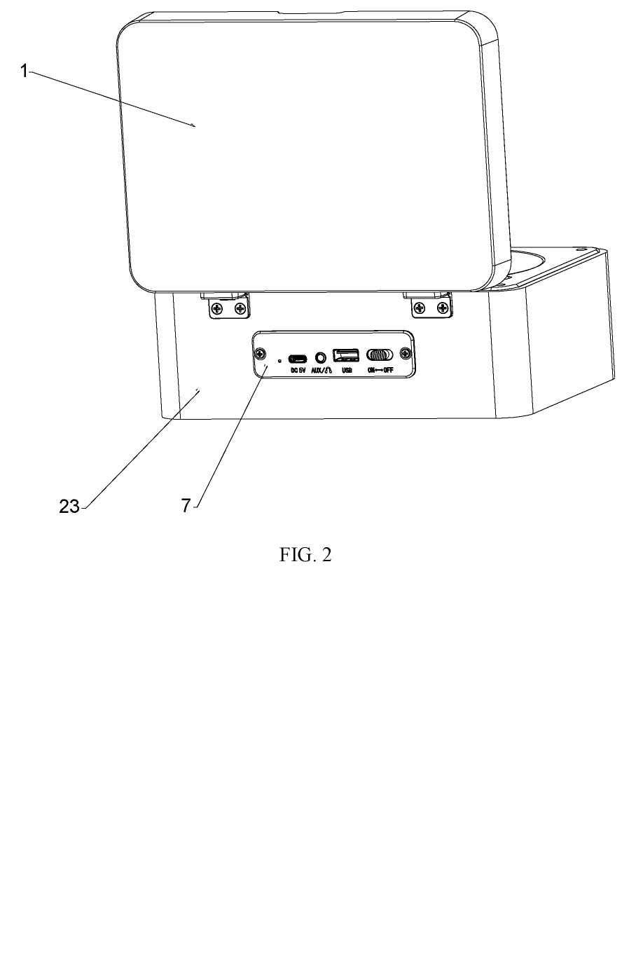

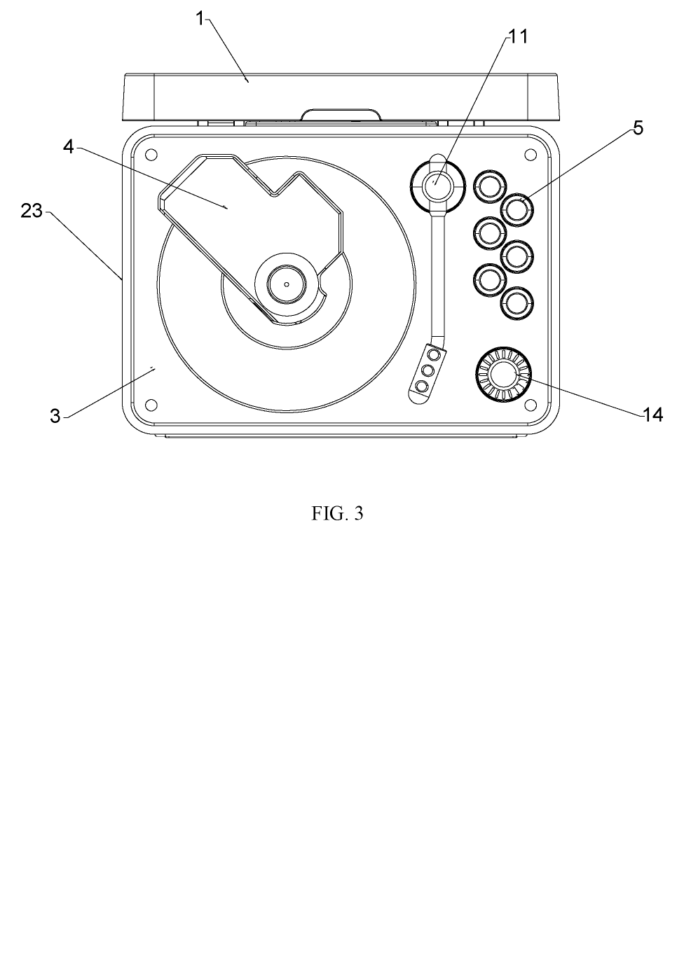

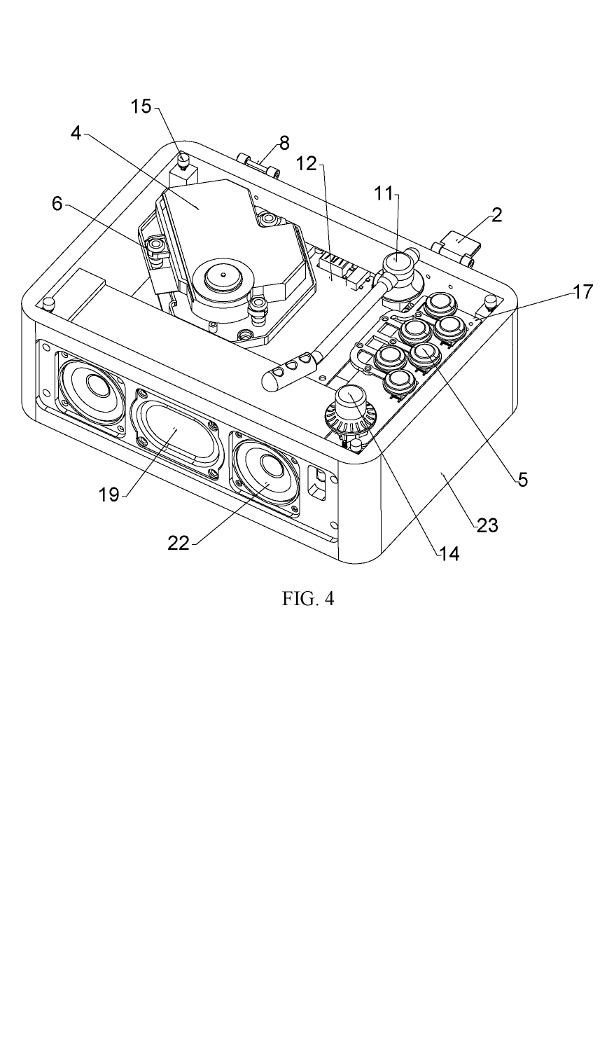

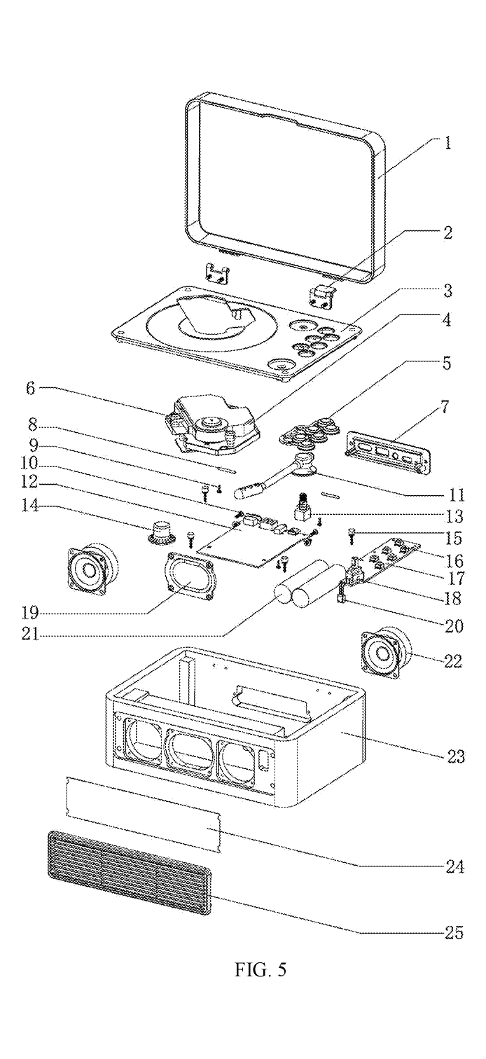

Referring to FIGS. 1, 2, 3, 4 and 5, the embodiment of the present disclosure provides a wooden-box CD playback device with improved sound quality, including a cover body, a wooden enclosure, an acoustic chamber assembly, a button-volume knob circuit board, a main control circuit board, a playback mechanism, a tonearm assembly and a battery.

A back side of the cover body is hinged to the wooden enclosure, such that the cover body is opened or closed relative to the wooden enclosure. The cover body and the wooden enclosure are connected in a hinged manner, and by utilizing the rotational characteristics of a hinged structure, a user can open or close the cover body by applying a small force. This design not only facilitates the placement and removal of CDs by a user, but also enables the cover body to closely fit the wooden enclosure when closed, thereby providing a certain dustproof effect and an effect of protecting internal components. Preferably, the cover body is made of a transparent material, such as an acrylic material, so as not to affect observation of the playback state of a CD inside the device by the user.

The acoustic chamber assembly includes a speaker, a diaphragm, and the wooden enclosure. The speaker and the diaphragm are both fixedly mounted on the surface of the wooden enclosure. As a key component for sound output, the speaker generates vibration driven by electrical signals, thereby emitting sound. The diaphragm cooperates with the speaker to assist the speaker in better radiating sound and enhancing the sound propagation effect. By fixing the speaker and the diaphragm to the surface of the wooden enclosure, the wooden enclosure functions as a resonance box. The wooden enclosure made of solid wood has good acoustic characteristics, and the natural density and fiber structure thereof can effectively absorb and disperse sound waves, reduce resonance interference, and provide a stable acoustic foundation for audio output. Meanwhile, the structure of the wooden enclosure can reflect and refract sound, such that a reasonable soundstage distribution is formed within a specific space, thereby optimizing sound quality and enabling the user to hear fuller and more stereoscopic sound.

The playback mechanism is placed on a plastic mechanism tray. In one possible embodiment, damping silicone rubber is disposed around the playback mechanism, and a plastic mechanism tray is disposed below the damping silicone rubber for supporting the playback mechanism. The playback mechanism is a core component for reading CD information, and generates certain vibration during operation. The plastic mechanism tray provides a stable supporting platform for the playback mechanism, ensuring that the position of the playback mechanism within the device is fixed. The arrangement of the damping silicone rubber plays a key damping role. Since vibration of the playback mechanism during the CD playback process may affect reading accuracy, problems such as sound skipping or distortion may occur. The damping silicone rubber has elasticity and can absorb vibration energy generated by the playback mechanism, reducing transmission of vibration to other components of the device, thereby ensuring the stability of the operation of the playback mechanism, improving the accuracy of CD reading, and enhancing sound quality performance.

The button-volume knob circuit board is fixedly mounted inside the device, and the button-volume knob circuit board is configured to control the volume of the device. In one possible embodiment, the button-volume knob circuit board is provided with tactile keys, plastic buttons are disposed above the tactile keys, the button-volume knob circuit board is further connected to a volume encoder and an infrared receiving diode, and a plastic volume knob is disposed above the volume encoder. The tactile keys and the plastic buttons are combined to provide an operation interface for the user. The tactile keys are trigger elements for electronic control. When the user presses the plastic buttons, pressure is transmitted to the tactile keys to generate electrical signals. The electrical signals are transmitted to the main control circuit board to implement function controls such as playback, pause, and track switching. The volume encoder is a key component for precise volume adjustment. Rotation of the plastic volume knob drives the volume encoder to rotate, and the volume encoder converts information, such as a rotation angle, into an electrical signal. The main control circuit board adjusts a gain of an audio amplification module based on the electrical signals, thereby achieving precise volume adjustment. The infrared receiving diode is configured to receive signals transmitted by an infrared remote controller, such that the user can operate the device from a certain distance away, thereby improving the convenience of use.

The main control circuit board is fixed inside the wooden enclosure by first screws, and the main control circuit board, the playback mechanism, and the button-volume knob circuit board are connected via wires to implement signal transmission and control. The main control circuit board is fixed inside the wooden enclosure by the first screws, ensuring the position stability thereof. The circuit connection between the main control circuit board, the playback mechanism, and the button-volume knob circuit board realizes two-way signal transmission. The CD audio signals read from the playback mechanism are processed and converted by the main control circuit board, and then transmitted to the audio amplification module for amplification and output. Meanwhile, the main control circuit board receives control signals from the button-volume knob circuit board, controls the working state of the playback mechanism according to user operation instructions, such as playback, pause, seeking, etc., and adjusts parameters such as the volume of audio output, ensuring that the device operates normally according to user needs.

The tonearm assembly is provided with a tonearm knob and a tonearm encoder, and the tonearm encoder is connected to the tonearm knob. The tonearm knob is configured for a user to manually operate the position of a tonearm. When the user rotates the tonearm knob, the tonearm moves correspondingly. The tonearm encoder monitors position changes of the tonearm in real time and converts position information of the tonearm into electrical signals. The electrical signals are transmitted to the main control circuit board, and the main control circuit board precisely controls the movement of the tonearm according to the electrical signals, thereby ensuring that a pickup head accurately positions at different track positions on a CD. A high-precision measurement function of the tonearm encoder enables positioning of the tonearm to be more precise, thereby avoiding deviation of the pickup head during reading of CD information, improving accuracy of audio reading, and ensuring stability and purity of sound quality.

The battery is mounted in a battery mounting position reserved inside the device, and the battery supplies power to the device. The battery is mounted in the reserved battery mounting position, thereby ensuring fixation of the battery inside the device and preventing the battery from shaking or shifting during movement of the device. As a power source, the battery provides the required electrical energy for various components inside the device. During operation of the device, the battery outputs direct current, and after adjustment and distribution by a power management circuit, stable voltage and current are provided for components such as the playback mechanism, the main control circuit board, and the button-volume knob circuit board. This power supply method enables the device to be free from dependence on an external power socket and have a capability of mobile use, thereby facilitating the use of the device by the user in different scenarios.

In one possible embodiment, the back side of the cover body is connected to one end of a hinge via a hinge pin, and the other end of the hinge is fixed on the wooden enclosure. Specifically, a combination of the hinge pin and the hinge is a common hinged implementation manner. The hinge pin connects the back side of the cover body with the hinge, such that the cover body can rotate around a shaft of the hinge. The other end of the hinge is fixed to the wooden enclosure, thereby providing a stable supporting point for the rotation of the cover body. This structure can ensure that the cover body remains stable during frequent opening and closing processes and is less likely to shake or detach, thereby ensuring the reliability and durability of use of the device.

In one possible embodiment, the device further includes a plastic panel. The plastic panel is mounted at an upper opening of the wooden enclosure, and the plastic panel and the wooden enclosure are connected via silicone rubber screw plugs.

Specifically, the plastic panel is mounted at the upper opening of the wooden enclosure and plays the roles of protection and decoration. The plastic panel can prevent dust, debris, and the like from entering the device, thereby protecting internal electronic components. Meanwhile, the appearance design of the plastic panel can be customized according to different aesthetic requirements, thereby improving the overall appearance of the device. The silicone rubber screw plugs connect the plastic panel and the wooden enclosure, and screws are used for fixing the positions of the two, thereby ensuring firm installation of the plastic panel. The silicone rubber plugs further have a sealing effect to prevent dust and moisture from entering the device via screw holes, thereby further protecting internal components of the device and prolonging the service life of the device.

In one possible embodiment, the wooden enclosure is made of solid wood or an engineered wood board, the solid wood is selected from one of oak wood, walnut wood, or cherry wood, and the engineered wood board is selected from one of medium-density fiberboard, particle board, plywood, or oriented strand board; and the wall thickness of the wooden enclosure (23) is 60 mm, 90 mm, or 120 mm.

Specifically, solid wood materials, such as oak wood, walnut wood, and cherry wood, have unique acoustic properties, and the natural density and fiber structures thereof can effectively absorb and disperse sound waves, reduce resonance interference, and provide a good acoustic environment for audio output. In addition, engineered wood boards may also be used. An appropriate wall thickness is also crucial to the acoustic effect of the wooden enclosure. The wall thickness designed as 6 cm, 9 cm, or 12 cm can not only ensure that the wooden enclosure has sufficient strength and is not easily deformed, but also enable the wooden enclosure to achieve a good balance in sound reflection and sound absorption. An excessively thin wall thickness may cause excessive resonance of the wooden enclosure, thereby affecting sound quality; whereas an excessively thick wall thickness may make sound excessively dull, which is also unfavorable for the improvement of sound quality.

In one possible embodiment, the device further includes a plastic interface. The plastic interface is fixed to a rear portion of the wooden enclosure by second screws, and the plastic interface includes at least one of an audio output port, a USB port, and a power port.

Specifically, the plastic interface is fixed to the rear portion of the wooden enclosure by the second screws, thereby ensuring stability of the interface and making the interface less likely to loosen. The audio output port is configured to connect an external audio device, such as a sound box or earphones, and output an audio signal played by the device, thereby obtaining a better audio playback effect. The USB port may be configured to connect an external storage device, such as a USB flash drive, to achieve playback of music files stored in the USB flash drive, or may be configured for functions such as software upgrading of the device. The power port is configured to connect an external power adapter to charge the device when battery power is insufficient, thereby ensuring continuous operation of the device. Arrangement of the interfaces greatly expands functions and application scenarios of the device and satisfies diversified requirements of users.

In one possible embodiment, the outer sides of the speaker and the diaphragm are sequentially covered with a dustproof fabric and a speaker grille.

Specifically, the dustproof fabric is located at an outermost side of the speaker and the diaphragm, and mainly plays a dustproof role. The dustproof fabric can prevent fine particles, such as dust and hair, from entering gaps between the speaker and the diaphragm, thereby avoiding the influence of the debris on the normal vibration of the speaker and the diaphragm, and ensuring that sound quality is not affected. Based on the dustproof fabric, the speaker grille further protects the speaker and the diaphragm. The speaker grille can not only prevent relatively large objects from directly contacting the speaker and the diaphragm and causing damage, but can also provide certain sound diffusion and sound modification effects, such that sound is more uniformly propagated, thereby improving the auditory experience of the user.

The use process of the present disclosure is as follows:
1. Preparation: check whether the appearance of the device is damaged, and determine that battery power is sufficient or an external power supply is properly connected (when power is supplied via the power port).
2. Start the device: the cover body is opened relative to the wooden enclosure through a hinged structure (cooperation between the hinge and the hinge pin), and a CD is placed at a designated position inside the device. Close the cover body, and at this time, the cover body closely fits the wooden enclosure to provide a dustproof effect and an effect of protecting internal components.
3. Operation control: the user may operate through the button-volume knob circuit board. Press the tactile keys (by applying force through the plastic buttons above), generated electrical signals are transmitted to the main control circuit board to execute instructions such as playback, pause, and track switching. Rotation of the plastic volume knob drives the volume encoder below to rotate. The volume encoder converts rotation information into electrical signals and sends the electrical signals to the main control circuit board, and the main control circuit board adjusts the gain of the audio amplification module according to the electrical signals, thereby achieving precise volume adjustment. In addition, an infrared remote controller may further be used to send signals to the device, and after the infrared receiving diode receives the signals and transmits the signals to the main control circuit board to complete corresponding operations, thereby increasing operation convenience.
4. Disc information reading: after the user issues a playback instruction, the main control circuit board controls the playback mechanism to start operating. The playback mechanism is placed on the plastic mechanism tray, and the damping silicone rubber around the playback mechanism reduces the influence of vibration generated during operation thereof on reading accuracy. The playback mechanism acquires audio information from the CD through an optical reading manner and converts the audio information into electrical signals to be transmitted to the main control circuit board.
5. Signal processing and transmission: after receiving audio electrical signals transmitted by the playback mechanism, the main control circuit board processes and converts the audio electrical signals and then transmits processed signals to the audio amplification module for amplification. Meanwhile, the main control circuit board further controls the operating state of the playback mechanism according to the operation instructions of the user (such as playback, pause, and track seeking).
6. Tonearm positioning: During playback, if track switching is required, the user may rotate the tonearm knob on the tonearm assembly. The tonearm knob drives the tonearm to move, and the tonearm encoder connected to the tonearm monitors position changes of the tonearm in real time and converts position information into electrical signals to be transmitted to the main control circuit board. The main control circuit board precisely controls the movement of the tonearm according to the electrical signals, such that the pickup head accurately positions at a target track position on the CD, thereby ensuring the accuracy of audio reading.
   Sound output: amplified audio signals are transmitted to the speaker in the acoustic chamber assembly. The speaker generates vibration under the driving of the electrical signals and drives the diaphragm to cooperatively operate, thereby emitting sound. The wooden enclosure is made of a solid wood material (such as oak wood, walnut wood, or cherry wood), and the natural density and fiber structure thereof effectively absorb and disperse sound waves, reduce resonance interference, and provide a stable acoustic foundation for audio output. Meanwhile, the wooden enclosure reflects and refracts sound, thereby optimizing sound quality. The dustproof fabric and the speaker grille sequentially covering the outer sides of the speaker and the diaphragm can not only prevent dust and other debris from entering the device and affecting sound emission, but can also provide certain sound diffusion and sound modification effects, thereby enabling the user to hear fuller and more stereoscopic sound.
7. Device connection and expansion functions (if necessary): the plastic interface of the device is located at the rear portion of the wooden enclosure and fixed by the second screws. If the user intends to connect an external audio device (such as a sound box or earphones), an audio cable may be connected into the audio output port (such as a 3.5 mm earphone jack or an RCA interface) to obtain a better audio playback effect; if music files in an external storage device (such as a USB flash drive) are to be played, the USB flash drive may be inserted into the USB port (such as a USB Type-A port or a USB Type-C port); and when battery power is insufficient, the device is charged by using a power adapter through the power port, thereby ensuring continuous operation of the device.
8. Device shutdown: after use is completed, the user may issue a playback stop instruction through the button-volume knob circuit board, then open the cover body, take out the CD, and close the cover body, thereby completing the use process.

The above has described the present disclosure in detail with reference to a general description and specific embodiments. It should be understood that, based on the technical concept of the present disclosure, various conventional modifications or further innovations may be made to the specific embodiments described above. However, any technical solutions obtained through such conventional modifications or further innovations shall also fall within the scope of protection of the claims of the present disclosure, provided that they do not depart from the technical concept of the present disclosure.

What is claimed is:

1. A wooden-box CD playback device with improved sound quality, comprising a cover body (1), a wooden enclosure (23), an acoustic chamber assembly, a button-volume knob circuit board (17), a main control circuit board (12), a playback mechanism (4), a tonearm assembly, and a battery (21),
wherein a back side of the cover body (1) is hinged to the wooden enclosure (23), such that the cover body (1) is opened or closed relative to the wooden enclosure (23);
the acoustic chamber assembly comprises a speaker (22), a diaphragm (19), and the wooden enclosure (23), wherein the speaker (22) and the diaphragm (19) are both fixedly mounted on a surface of the wooden enclosure (23), and the playback mechanism (4) is placed on a plastic mechanism tray (6);
the button-volume knob circuit board (17) is fixedly mounted inside the device and configured to control a volume of the device;
the main control circuit board (12) is fixed inside the wooden enclosure (23) by first screws (9); the main control circuit board (12), the playback mechanism (4), and the button-volume knob circuit board (17) are connected via wires to implement signal transmission and control;
the tonearm assembly is provided with a tonearm knob (11) and a tonearm encoder (13); the tonearm encoder (13) is connected to the tonearm knob (11); and
the battery (21) is mounted in a battery mounting position reserved inside the device and supplies power to the device.

2. The wooden-box CD playback device with improved sound quality according to claim 1, wherein the back of the cover body (1) is connected to one end of a hinge (2) via a hinge pin (8), and the other end of the hinge (2) is fixed to the wooden enclosure (23).

3. The wooden-box CD playback device with improved sound quality according to claim 1, further comprising a plastic panel (3), wherein the plastic panel (3) is mounted at an upper opening of the wooden enclosure (23), and the plastic panel (3) and the wooden enclosure (23) are connected via silicone rubber screw plugs (15).

4. The wooden-box CD playback device with improved sound quality according to claim 1, wherein the button-volume knob circuit board (17) is provided with tactile keys (16), and a plastic button (5) is disposed above each tactile key (16); the button-volume knob circuit board (17) is further connected to a volume encoder (18) and an infrared receiving diode (20), and a plastic volume knob (14) is disposed above the volume encoder (18).

5. The wooden-box CD playback device with improved sound quality according to claim 1, wherein damping silicone rubber (6) is disposed around the playback mechanism (4), and a plastic mechanism tray is disposed below the damping silicone rubber (6) for supporting the playback mechanism (4).

6. The wooden-box CD playback device with improved sound quality according to claim 1, wherein the wooden enclosure (23) is made of solid wood or an engineered wood board, the solid wood is selected from one of oak wood, walnut wood, or cherry wood, and the engineered wood board is selected from one of medium-density fiberboard, particle board, plywood, or oriented strand board; a wall thickness of the wooden enclosure (23) is 6 cm, 9 cm, or 12 cm.

7. The wooden-box CD playback device with improved sound quality according to claim 1, wherein the device further comprises a plastic interface (7), the plastic interface (7) is secured to a rear portion of the wooden enclosure (23) by second screws (10), and the plastic interface (7) comprises at least one of an audio output port, a USB port, and a power port.

8. The wooden-box CD playback device with improved sound quality according to claim 1, wherein outer sides of the speaker (22) and the diaphragm (19) are sequentially covered with a dustproof fabric (24) and a speaker grille (25).
